(19) United States
(12) Patent Application Publication
(10) Pub. No.: US 2025/0029032 A1
(43) Pub. Date: Jan. 23, 2025

(54) SHIFT GENERATION SYSTEM, SHIFT GENERATION METHOD, AND NON-TRANSITORY RECORDING MEDIUM STORING COMPUTER-READABLE SHIFT GENERATION PROGRAM

(71) Applicant: KONICA MINOLTA, INC., Tokyo (JP)

(72) Inventor: Hiroki TAJIMA, Tokyo (JP)

(21) Appl. No.: 18/735,473

(22) Filed: Jun. 6, 2024

(30) Foreign Application Priority Data
Jul. 20, 2023 (JP) 2023-117997

(51) Int. Cl. G06Q 10/0631; G06Q 10/0639

(52) U.S. Cl. CPC G06Q 10/063116; G06Q 10/06398

(57) ABSTRACT

A shift generation system includes a hardware processor that accepts a shift condition and member information, generates a shift for a member based on the shift condition and the member information, evaluates an achievement state of the shift condition for the generated shift, predicts an effect of a change in the shift condition on the evaluation, and presents the predicted effect.

### CROSS-REFERENCE TO RELATED APPLICATION

Japanese patent application No. 2023-117997 filed on Jul. 20, 2023, including description, claims, drawings, and abstract the entire disclosure is incorporated herein by reference in its entirety.

### BACKGROUND OF THE INVENTION

### 1. Technical Field

The present invention relates to a shift generation system, a shift generation method, and a non-transitory recording medium storing a computer-readable shift generation program.

### 2. Description of Related Art

Conventionally, a genetic algorithm has been used for generating a shift for staff of an organization. In automatic generation of shifts using a genetic algorithm, a plurality of shifts are generated as individuals for each generation based on a set shift condition (rule). Then, the individuals are evolved to individuals having a higher evaluation value indicating an extent to which the shift condition is satisfied.

However, there are relatively many shift conditions to be set in automatic generation of shifts using a genetic algorithm, and it is not easy to appropriately set the shift conditions. That is, when a shift condition is strictly set, the number of solutions may be extremely small, or an evaluation value may not converge to 100% and no solution may exist. It is not easy for a user to recognize whether or not shift conditions enable the evaluation value to converge to 100%, because many shift conditions are set. Therefore, there is a problem that trial and error of repeatedly changing a shift condition, generating a shift, and calculating an evaluation value is required, which is complicated.

Japanese Unexamined Patent Application Publication No. 2001-175639 discloses the following related technique. A schedule plan is used as a parent chromosome, a child chromosome is generated by crossover, the child chromosome is mutated or biased, and an extent to which the child chromosome satisfies a preset condition is evaluated. Then, a parent chromosome or a child chromosome having a poor evaluation value is selected.

### SUMMARY OF THE INVENTION

However, the above-described related technique has a problem that it is not possible to solve the complication of trial and error in the optimization of a shift condition in the automatic generation of shifts.

The present invention has been made in consideration of the above-described circumstances. That is, an object of the present invention is to provide a shift generation system, a shift generation method, and a non-transitory recording medium storing a computer-readable shift generation program, which can eliminate the complication of trial and error in optimization of a shift condition in automatic generation of a shift.

To achieve at least one of the abovementioned objects, according to an aspect of the present invention, a device reflecting one aspect of the present inventions comprises the followings.

A shift generation system including a hardware processor that accepts a shift condition and member information, generates a shift for a member based on the shift condition and the member information, evaluates an achievement state of the shift condition for the generated shift, predicts an effect of a change in the shift condition on the evaluation, and presents the predicted effect.

To achieve at least one of the abovementioned objects, according to an aspect of the present invention, a method reflecting one aspect of the present inventions comprises the followings.

A shift generation method executed by a shift generation system that generates a shift for a member, the shift generation method including: (a) accepting a shift condition and member information; (b) generating the shift for the member based on the shift condition and the member information; (c) evaluating an achievement state of the shift condition for the generated shift; (d) predicting an effect of a change in the shift condition on the evaluation; and (e) presenting the effect obtained in (d).

To achieve at least one of the abovementioned objects, according to an aspect of the present invention, a non-transitory recording medium reflecting one aspect of the present inventions comprises the followings.

A non-transitory recording medium storing a computer-readable shift generation program for causing a computer to execute processing including: (a) accepting a shift condition and member information; (b) generating a shift for a member based on the shift condition and the member information; and (c) evaluating an achievement state of the shift condition for the generated shift; (d) predicting an effect of a change in the shift condition on the evaluation; and (c) presenting the effect obtained in (d).

The objects, features, and characteristics of this invention other than those set forth above will become apparent from the description given herein below with reference to preferred embodiments illustrated in the accompanying drawings.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating a schematic configuration of an entire system according to an embodiment of the present invention;

FIG. 2 is a block diagram illustrating a schematic configuration of an information processing terminal;

FIG. 3 is a diagram illustrating an example of a shift condition acceptance screen;

FIG. 4 is a block diagram illustrating a schematic configuration of a server;

FIG. 5 is a block diagram illustrating functions of a CPU;

FIG. 6 is a diagram illustrating an example of a shift;

FIG. 7A is an explanatory diagram for explaining evaluation of an achievement state of a shift condition due to a change in a shift condition;

FIG. 7B is an explanatory diagram for explaining evaluation of an achievement state of a shift condition due to a change in a shift condition;

FIG. 8A is an explanatory diagram for explaining evaluation of an achievement state of a shift condition due to a change in shift conditions by limiting the shift conditions to an achievable shift condition and another shift condition;

FIG. 8B is an explanatory diagram for explaining evaluation of an achievement state of a shift condition due to a change in shift conditions by limiting the shift conditions to an achievable shift condition and another shift condition;

FIG. 9 is an example of a flowchart illustrating an operation of the system;

FIG. 10 is an example of a flowchart illustrating an operation of the system to perform a prediction process; and

FIG. 11 is another example of a flowchart illustrating the operation of the system to perform the prediction process.

### DETAILED DESCRIPTION

Hereinafter, one or more embodiments of the present invention will be described with reference to the drawings. However, the scope of the invention is not limited to the disclosed embodiments.

Hereinafter, a shift generation system, a shift generation method, and a non-transitory recording medium storing a computer-readable shift generation program according to embodiments of the present invention will be described with reference to the accompanying drawings. Note that in the description of the drawings, the same components are denoted by the same reference signs, and redundant descriptions are omitted. In addition, dimensional ratios in the drawings are exaggerated for convenience of description and may be different from actual ratios.

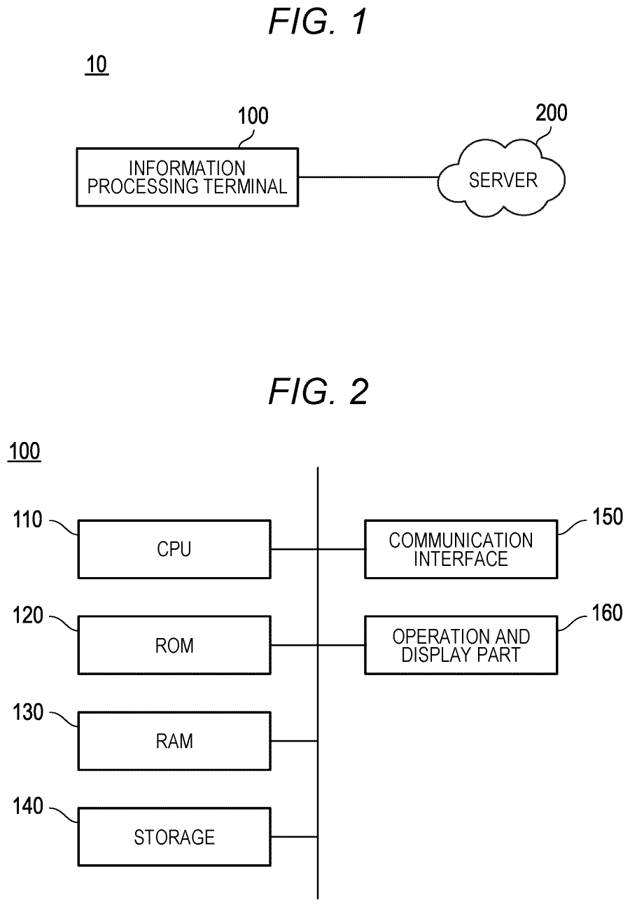

FIG. 1 is a diagram illustrating a schematic configuration of an entire system 10 according to an embodiment of the present invention.

As illustrated in FIG. 1, the system 10 includes an information processing terminal 100 and a server 200. The information processing terminal 100 and the server 200 are configured to be connectable to each other via a network. The server 200 is, for example, a cloud server, but may be an on-premise server (server device) or the like. The server 200 forms a shift generation system. The server 200 and the information processing terminal 100 may form a shift generation system.

The system 10 may be installed inside a facility of an organization, and some or all of the constituent elements may be installed outside the facility (e.g., a headquarters house of a corporation that operates a plurality of facilities). The organization includes any organization that employs a plurality of members (personnel). The members include any personnel who work according to a work shift (hereinafter, also simply referred to as “shift”).

Hereinafter, in order to simplify the description, a case will be described as an example in which the organization is an organization that operates a care facility, and a shift for staff members who are members who care in the care facility is generated.

### (Information Processing Terminal 100)

The information processing terminal 100 is, for example, a terminal used by a user such as a facility manager, a manager, or an administrator of the care facility, and is a desktop PC, a notebook PC, a tablet PC, a smartphone, or the like.

FIG. 2 is a block diagram illustrating a schematic configuration of the information processing terminal 100.

As illustrated in FIG. 2, the information processing terminal 100 includes a central processing unit (CPU) 110, a read only memory (ROM) 120, a random access memory (RAM) 130, a storage 140, a communication interface 150, and an operation and display part 160. The respective components are communicably connected to each other via a bus.

The CPU 110 performs control of the above-described components and various kinds of arithmetic processing in accordance with programs recorded in the ROM 120 and the storage 140. Specific functions of CPU 110 will be described later.

The ROM 120 stores therein various programs or various kinds of data.

The RAM 130, as a workspace, temporarily stores therein a program and data.

The storage 140 is provided with a hard disc drive (HDD), a solid state drive (SDD), or the like, and stores various programs including an operating system and various kinds of data. For example, an application for accepting an input (including an instruction and the like) from a user and transmitting and receiving various kinds of information to and from another apparatus such as the server 200 is installed in the storage 140. Further, an application for outputting (displaying) information to the operation and display part 160 is installed in the storage 140.

The communication interface 150 is an interface for communicating with other apparatuses. As the communication interface 150, a communication interface based on various wired or wireless standards is used.

The operation and display part 160 is, for example, a touch screen type display, displays various kinds of information, and accepts various kinds of input from the user.

The CPU 110 accepts staff member information input by the user on the operation and display part 160. The staff member information forms member information. The staff member information includes, for example, information regarding the staff members, which is used to generate the shift, such as the number of staff members, acquired qualifications, occupation types, and work forms. The staff members include full-time and part-time care staff members, nursing staff members, nutritionists, and the like. The CPU 110 transmits the accepted staff member information to the server 200.

The CPU 110 accepts a shift condition input by the user on the operation and display part 160. The shift condition is a condition that needs to be satisfied by a shift to be generated, and is a rule for generating the shift. The shift condition may include a required number of persons per day for each shift symbol and restrictions on consecutive setting of shift symbols, such as a night shift followed by a paid vacation. Each shift symbol is a unique symbol corresponding to a combination of work hours and a work time period. The shift condition may include the number of consecutive days available for work, the number of consecutive days available for vacation, the number of public holidays (weeks or months) for each staff member, working hours (weeks or months) for each staff member, and a settable shift symbol for each staff member. The shift condition may include the number of working days (weekly or monthly) for each staff member, a desired working day for each staff member, and the like. The CPU 110 transmits the accepted shift condition to the server 200.

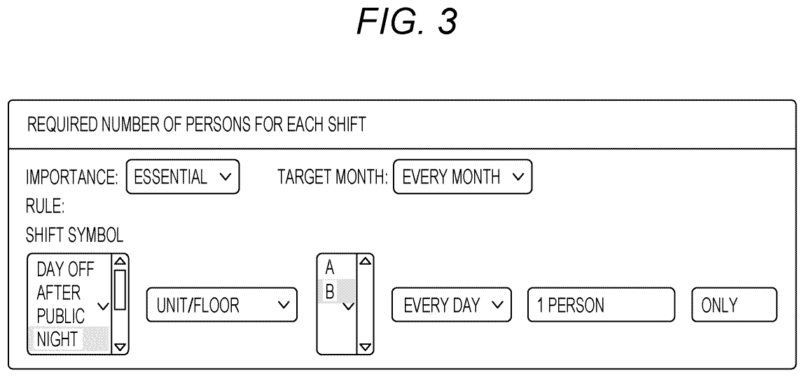

FIG. 3 is a diagram illustrating an example of a shift condition acceptance screen. The shift condition acceptance screen is displayed on the operation and display part 160. The CPU 110 accepts a shift condition input by the user on the shift condition acceptance screen.

In the example illustrated in FIG. 3, a required number of persons per day for each shift symbol (a required number of persons for each shift) is input as a shift condition on the shift condition acceptance screen. That is, a condition that a shift symbol “night” is assigned to one of staff members belonging to a unit “unit B” all day is input as a shift condition in every month.

### (Server 200)

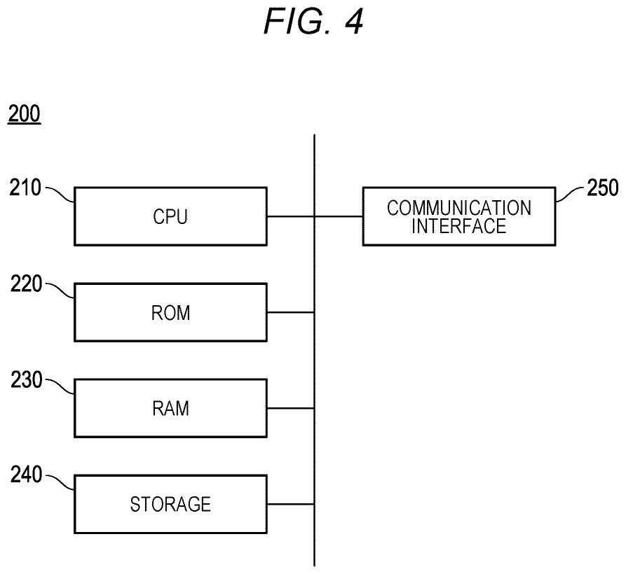

FIG. 4 is a block diagram illustrating a schematic configuration of the server 200.

As illustrated in FIG. 4, the server 200 includes a CPU 210, a ROM 220, a RAM 230, a storage 240, and a communication interface 250. The components are communicably connected to each other via a network or a bus. The CPU 210 forms a controller. The CPU 210 forms a hardware processor.

Since configurations and basic functions of the CPU 210, the ROM 220, the RAM 230, the storage 240, and the communication interface 250 are similar to those of the respective corresponding elements of the information processing terminal 100, redundant description is omitted. Specific functions of CPU 210 will be described later.

In the storage 240, a program for the CPU 210 to perform each process is installed. The member information and the shift condition received from the information processing terminal 100 or the like are stored in the storage 240.

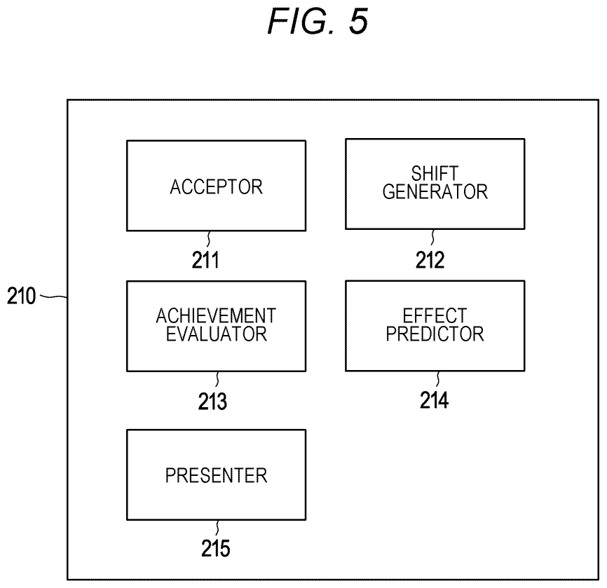

FIG. 5 is a block diagram illustrating functions of the CPU 210. The CPU 210 operates in accordance with the program to function as an acceptor 211, a shift generator 212, an achievement evaluator 213, an effect predictor 214, and a presenter 215. The shift generator 212 forms a generator. The effect predictor 214 forms a predictor.

### (Specifying and Presentation of Unachievable Shift Condition)

The acceptor 211 accepts a shift condition and staff member information. Specifically, for example, the acceptor 211 accepts the shift condition and the staff member information by receiving the shift condition and the staff member information from the information processing terminal 100 via the communication interface 250. Since the shift condition is a condition that needs to be satisfied by a shift to be generated, a plurality of shift conditions can usually be accepted as the condition that needs to be satisfied by the shift to be generated. The acceptor 211 may store the accepted shift condition and the accepted staff member information to the storage 240.

The shift generator 212 generates a shift for each staff member based on the shift condition and the staff member information. The shift generator 212 generates the shift using, for example, a genetic algorithm. The shift generator 212 may generate the shift by using Tabu search or the like. The shift is obtained by assigning a shift symbol to each staff member on a daily basis. In order to simplify the description, a case where the shift is generated using the genetic algorithm will be described as an example.

In automatic generation of shifts using the genetic algorithm, a plurality of shifts are generated as individuals for each generation based on set shift conditions. Then, while repeating crossover, mutation, selection, and the like between shifts, each individual is evolved to an individual having a higher evaluation value indicating an extent to which a shift condition is satisfied. An evaluation value is calculated for each individual by the genetic algorithm. The evaluation value is an extent to which the shift condition is satisfied. The evaluation value for each individual is calculated as the sum of corrected evaluation values obtained by multiplying the evaluation values for the respective shift conditions used for generating the individual by respective weighting coefficients. That is, the evaluation value for each individual is the sum of the corrected evaluation values calculated for all the shift conditions used to generate the individual. Then, among the plurality of individuals generated for each generation, an individual having a relatively low evaluation value is selected, and an individual having the highest evaluation value is finally generated.

Specifically, for example, when the number of shift conditions used for generating a shift (individual) is two, a corrected evaluation value for each shift condition is calculated by the following expression.

A corrected evaluation value a for a shift condition A=a weighting coefficient α×an evaluation value for the shift condition A

A corrected evaluation value b for a shift condition B=a weighting coefficient β×an evaluation value for the shift condition B

Then, an evaluation value (overall evaluation value) for each individual is calculated, for example, by the following expression.

An evaluation value for an individual=the corrected evaluation value a+the corrected evaluation value b

An individual is selected based on the evaluation values for the individuals. Therefore, a shift condition to be prioritized in shift generation for each generation is determined by the weighting coefficients. Each of the weighting coefficients forms a priority for each shift condition in the shift generation (calculation).

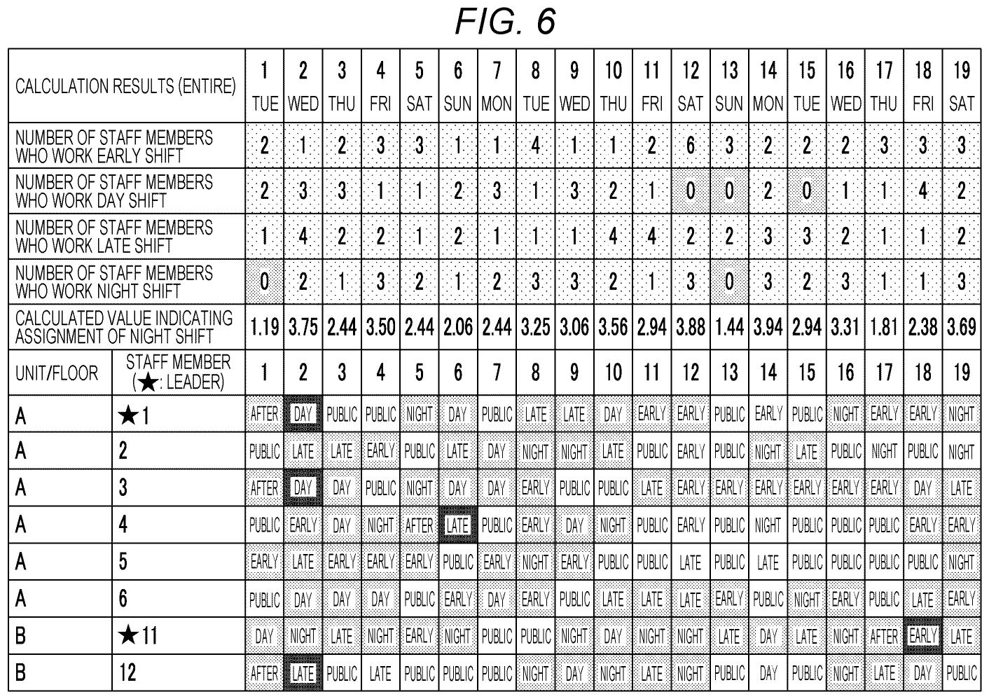

FIG. 6 is a diagram illustrating an example of a generated shift.

As illustrated in FIG. 6, for the shift, a shift symbol is assigned to each staff member on a daily basis. Shift symbols “day”, “early”, “late”, “night”, “after”, and “public” mean a day shift, an early shift, a late shift, a night shift, a compensatory day off after a night shift, and a public holiday, respectively.

The achievement evaluator 213 evaluates, as an evaluation value, an achievement state of a shift condition (an extent to which the shift condition is satisfied) for the generated shift. The achievement evaluator 213 calculates and outputs an evaluation value for each shift condition for each individual (shift generated using the genetic algorithm) for which an evaluation value is continuously generated. For example, in a case where a shift condition is a required number of persons per day for each shift symbol, an evaluation value can be the total squared value of a sufficiency rate for a required number of persons per day for each shift symbol. In this case, when the sufficiency rates of all the shift symbols are 1 (100%), the evaluation value is 1 (100%).

The effect predictor 214 predicts the effect of a change in a shift condition on the evaluation by the achievement evaluator 213. In a case where a plurality of shift conditions are set, the effect predictor 214 detects a shift condition of which an achievement state has been evaluated by the achievement evaluator 213 and does not satisfy a predetermined criterion. Specifically, for example, the effect predictor 214 detects a shift condition for which the evaluation value does not reach 100%, which is set as the predetermined criterion, even after a predetermined time has elapsed after the start of the generation of a shift by the shift generator 212. The predetermined criterion is preferably 100%, but is not limited thereto, and can be appropriately set by experiment from the viewpoints of the calculation time and the increase rate of the evaluation value. The effect predictor 214 limits the shift conditions to one of specified shift conditions and causes the shift generator 212 to generate a shift. The effect predictor 214 can predict the effect on the evaluation based on whether or not the evaluation by the achievement evaluator 213 is improved by limiting the shift conditions to one shift condition. Specifically, in a case where an evaluation value for a shift generated based on one shift condition with respect to the shift condition is improved to 100%, the effect predictor 214 predicts that a change in the shift condition affects the evaluation value. In a case where the evaluation value for the shift generated based on the one shift condition with respect to the shift condition is not improved to 100%, the effect predictor 214 predicts that the change in the shift condition does not affect the evaluation value.

While the shift generator 212 is generating a shift for each generation using the genetic algorithm, the effect predictor 214 can detect a shift condition of which an achievement state does not satisfy the predetermined criterion even after a predetermined time has elapsed after the start of the shift generation. In response to the detection of shift conditions of which achievement states do not satisfy the predetermined criterion, the CPU 210 can cause the shift generator 212 to generate a shift based on any one of the detected shift conditions. In response to acceptance of one of the plurality of shift conditions by the acceptor 211, the CPU 210 may cause the shift generator 212 to generate a shift based on the one shift condition.

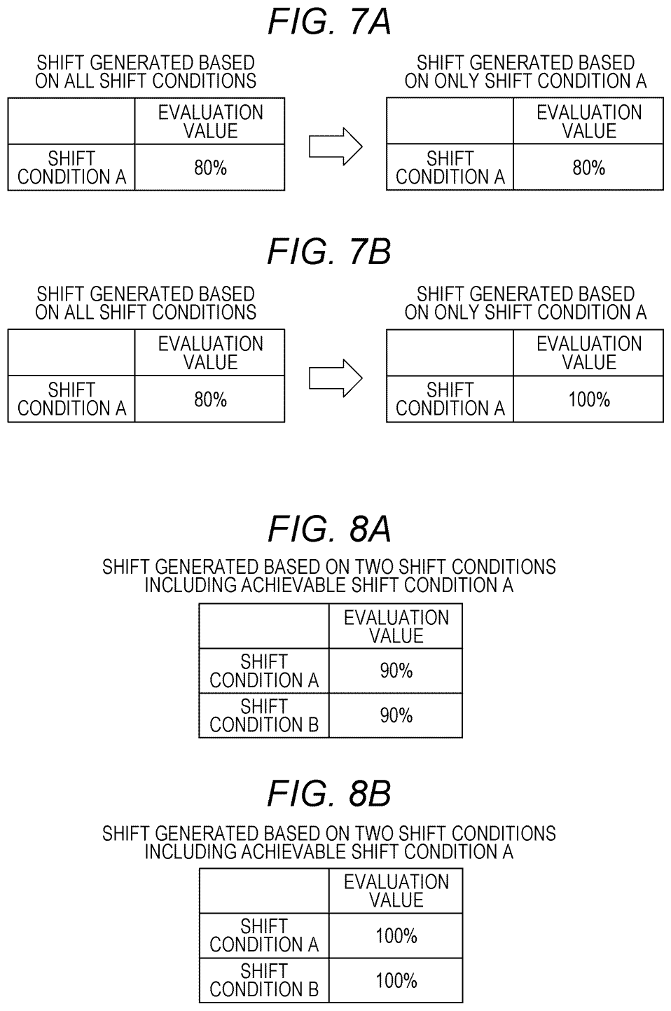

Each of FIGS. 7A and 7B is an explanatory diagram for explaining evaluation of an achievement state of a shift condition due to a change in a shift condition.

FIG. 7A illustrates an example in which an achievement state of a shift condition is not improved due to the change in a shift condition. In the example illustrated in FIG. 7A, an evaluation value for a shift generated based on all the shift conditions required to be satisfied by the generated shift is 80%. An evaluation value for a shift generated based on only one shift condition A is also 80%. Therefore, even in a case where the shift conditions are changed to the one shift condition A, the achievement state of the shift condition A is not improved. In this case, the shift condition A is specified as a shift condition that cannot be achieved in the first place in the shift generation based on the staff member information.

FIG. 7B illustrates an example in which an achievement state of a shift condition is improved due to a change in a shift condition. In the example of FIG. 7B, the evaluation value for a shift generated based on all the shift conditions required to be satisfied by the generated shift is 80%. An evaluation value for a shift generated based on only one shift condition A is 100%. Therefore, the achievement state of the shift condition A is improved by the change in the shift condition. In this case, the shift condition A is not a shift condition that cannot be achieved in the shift generation based on the staff member information. Therefore, the shift condition A is specified as a shift condition that can be achieved by increasing the priority in the shift generation using the genetic algorithm.

The effect of the change in the shift condition on the evaluation of the achievement state of the shift condition is obtained by the effect predictor 214 and presented by the presenter 215. Specifically, the presenter 215 presents whether or not the evaluation of the achievement state of the shift condition is improved by limiting the shift conditions to one shift condition. The presenter 215 transmits, for example, the shift condition (one shift condition) after the change and the evaluation value for the achievement state of the shift condition after the change to the information processing terminal 100 via the communication interface 250, and causes the operation and display part 160 of the information processing terminal 100 to display the transmitted shift condition and the transmitted evaluation value. Thus, the effect of the change in the shift condition on the evaluation of the achievement state of the shift condition is presented. The presenter 215 may present the shift conditions before and after the change and the evaluation values for the achievement states of the shift conditions before and after the change.

The presenter 215 may present the changed shift condition and the evaluation value for the achievement state of the shift condition by transmitting the changed shift condition and the evaluation value to an apparatus other than the information processing terminal 100. The presenter 215 may present the changed shift condition and the evaluation value of the achievement state of the changed shift condition by forming an image on a sheet in an image forming apparatus and outputting the sheet.

Since the changed shift condition and the evaluation value for the achievement state of the changed shift condition are presented, the user can grasp whether or not the changed shift condition is an achievable shift condition.

### (Prediction of Conflict Between Achievable Shift Condition and Another Shift Condition)

The effect predictor 214 limits the shift conditions to the shift condition for which the evaluation of the achievement state of the shift condition is improved due to a change in the shift condition and another shift condition other than the shift condition and causes the shift generator 212 to generate a shift. That is, the effect predictor 214 changes the shift conditions to a combination of an achievable shift condition and another shift condition by limiting the shift conditions to the combination of the achievable shift condition and the other shift condition, and causes the shift generator 212 to generate a shift. There may be one or more other shift conditions. In the following description, in order to simplify the description, it is assumed that the number of other shift conditions is one.

The effect predictor 214 predicts the effect of the change in the shift condition on the evaluation by the achievement evaluator 213 based on whether or not all of the limited shift conditions are achieved.

FIG. 8A and FIG. 8B are explanatory diagrams for explaining evaluation of an achievement state of a shift condition due to a change in the shift conditions by limiting the shift conditions to an achievable shift condition and another shift condition.

In FIG. 8A, even when the shift conditions are changed to the limited shift conditions, not all the evaluation values for the limited shift conditions become 100%. This indicates that it is impossible to generate a shift that satisfies both the achievable shift condition A and the other shift condition B. That is, it indicates that a conflict occurs between the shift condition A and the shift condition B.

In FIG. 8B, all the evaluation values for the limited shift conditions are 100% due to a change in the shift conditions by limiting the shift conditions. This indicates that it is possible to generate a shift that satisfies both the achievable shift condition A and the other shift condition B. That is, it indicates that there is no shift solution that satisfies both the shift condition A and the shift condition B, and no conflict occurs between the shift condition A and the shift condition B.

The presenter 215 presents whether or not all of the limited shift conditions are achieved due to a change in the shift conditions by limiting the shift conditions to the achievable shift condition and another shift condition. For example, the presenter 215 transmits the two shift conditions including the achievable shift condition after the change and the evaluation values for the achievement states of the two shift conditions to the information processing terminal 100 via the communication interface 250. Thus, the presenter 215 displays the shift conditions and the evaluation values on the operation and display part 160 of the information processing terminal 100. Thus, the presenter 215 presents the effect on the evaluation of the achievement states of the shift conditions due to the change in the shift conditions by limiting the shift conditions to the achievable shift condition and the other shift condition.

After the change, the two shift conditions including the achievable shift condition and the evaluation values for the achievement states of the two shift conditions are presented. Thus, the user can grasp whether or not the achievable shift condition causes a conflict with the other shift condition.

Operation of the system 10 will be described.

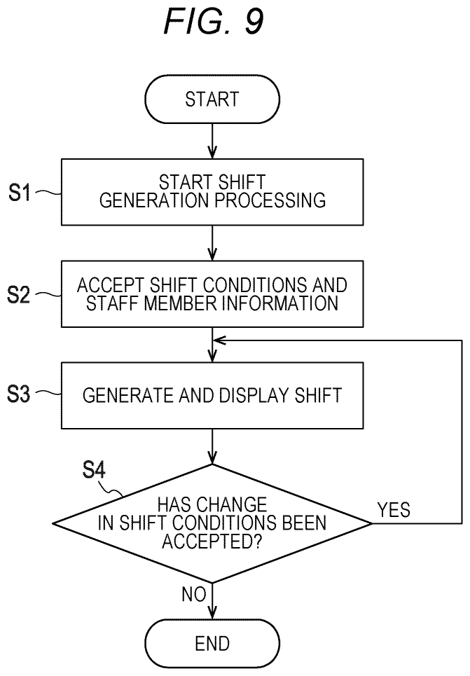

FIG. 9 is an example of a flowchart illustrating the operation of the system 10. Processing illustrated in this flowchart can be performed by the CPU 210 controlling each part according to a program stored in the storage 240 of the server 200.

The CPU 210 starts shift generation processing (S1). The CPU 210 causes the information processing terminal 100 to display a menu by, for example, transmitting the menu to the information processing terminal 100. Next, the CPU 210 receives, from the information processing terminal 100, a notification that a button for starting the shift generation processing has been selected in the menu, and thus starts the shift generation processing.

The CPU 210 accepts shift conditions and staff member information (S2). The CPU 210 may accept the shift conditions and the staff member information by receiving information input by the user to the information processing terminal 100.

The CPU 210 generates and presents a shift based on the shift conditions and the staff member information (S3). The CPU 210 can present the generated shift by transmitting the generated shift to the information processing terminal 100 and causing the information processing terminal 100 to display the generated shift. The CPU 210 may present the generated shift by transmitting the generated shift to an apparatus other than the information processing terminal 100. The CPU 210 may present the generated shift by transmitting the generated shift to the image forming apparatus and forming an image on a sheet.

In step S3, the CPU 210 may present an achievement state of each shift condition together with the shift.

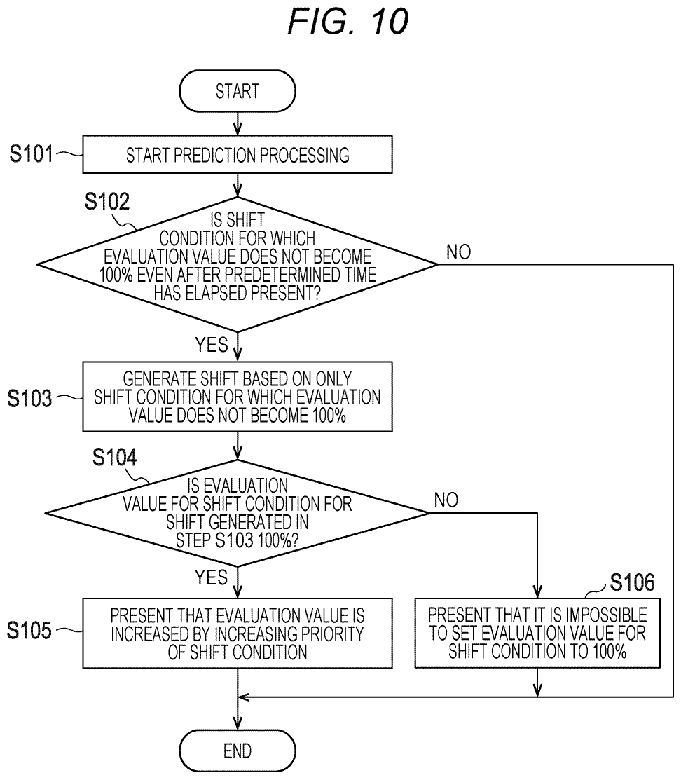

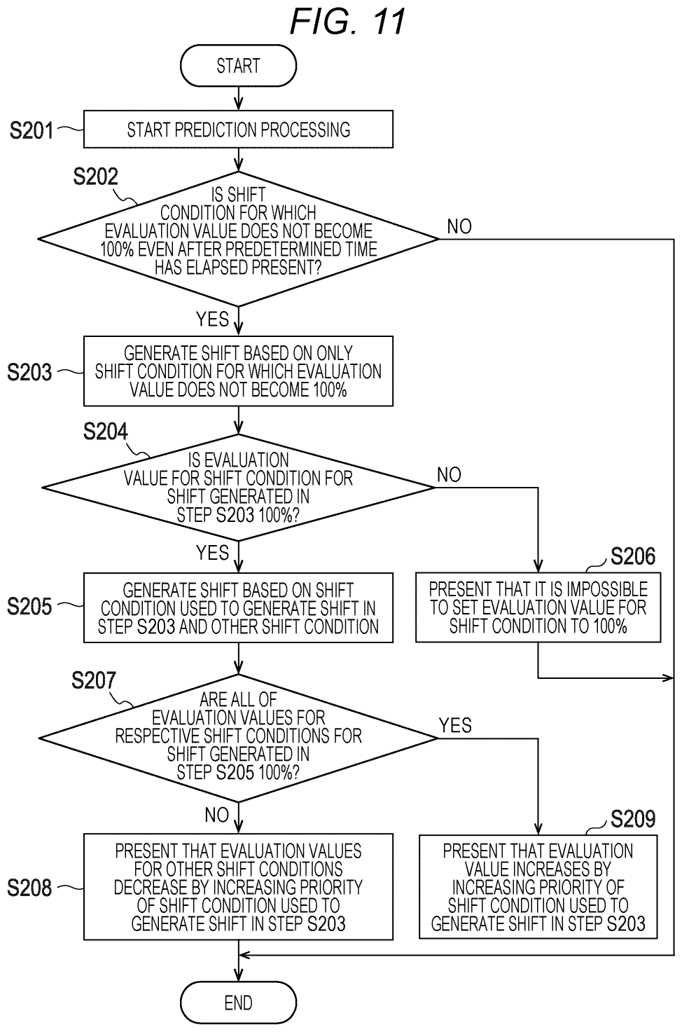

In step S3, prediction processing illustrated in FIGS. 10 and 11 may be performed. That is, for example, it is determined whether or not a shift condition for which an evaluation value does not become 100% even after a predetermined time has elapsed is present (see step S102 in FIG. 10).

The CPU 210 determines whether or not a change in the shift conditions has been accepted (S4). The CPU 210 may accept a change in the shift conditions by receiving information input by the user to the information processing terminal 100. For example, in a case where an unachievable shift condition is presented, the user can change the shift conditions to an achievable shift condition.

When determining that the change in the shift conditions has been accepted (S4: YES), the CPU 210 generates and presents a shift based on the shift condition after the change (S3). When determining that the change in the shift conditions has not been accepted (S4: NO), the CPU 210 ends the process.

FIG. 10 illustrates an example of a flowchart illustrating operation of the system 10 to perform the prediction process. This flowchart is a flowchart for specifying and presenting an unachievable shift condition. Processing illustrated in this flowchart can be performed by the CPU 210 controlling each part according to a program stored in the storage 240 of the server 200.

The CPU 210 starts the shift generation processing (S101). For example, the CPU 210 causes the information processing terminal 100 to display the menu by transmitting the menu to the information processing terminal 100. Then, the CPU 210 starts the shift generation processing by receiving, from the information processing terminal 100, a notification that the button for starting the shift generation processing has been selected in the menu.

The CPU 210 generates a shift for each generation based on a shift condition and the staff member information, and determines whether a shift condition for which an evaluation value does not become 100% even after a predetermined time has elapsed is present. That is, the CPU 210 detects a shift condition for which an evaluation value does not become 100% even after a predetermined time has elapsed (S102). When the CPU 210 determines that a shift condition for which an evaluation value does not become 100% even after a predetermined time has elapsed is not present (not detected) (S102: NO), the CPU 210 presents a shift that satisfies all the shift conditions, and ends the process.

When the CPU 210 determines that the shift condition for which the evaluation value does not become 100% even after the predetermined time has elapsed is present (detected) (S102: YES), the CPU 210 performs step S103. That is, the CPU 210 generates a shift based on only one of shift conditions for which evaluation values do not become 100% (S103).

The CPU 210 determines whether or not the evaluation value for the one shift condition for the shift generated in step S103 is 100% (S104).

When the CPU 210 determines that the evaluation value for the one shift condition for the shift generated in step S103 is 100% (S104: YES), the CPU 210 performs step S105. That is, the CPU 210 presents that the evaluation value is increased by increasing the priority of the shift condition (S105).

On the other hand, the CPU 210 determines that the evaluation value for the one shift condition for the shift generated in step S103 is not 100% (S104: NO), the CPU 210 performs step S106. That is, the CPU 210 presents that it is impossible to set the evaluation value for the shift to 100% (S106).

FIG. 11 illustrates another example of a flowchart illustrating the operation of the system 10 to perform the prediction process. This flowchart is a flowchart for predicting a conflict between an achievable shift condition and another shift condition in addition to specifying and presentation of an unachievable shift condition. Processing illustrated in this flowchart can be performed by the CPU 210 controlling each part according to a program stored in the storage 240 of the server 200.

The CPU 210 starts shift generation processing (S201). For example, the CPU 210 causes the information processing terminal 100 to display the menu by transmitting the menu to the information processing terminal 100. Then, the CPU 210 starts the shift generation processing by receiving, from the information processing terminal 100, a notification that the button for starting the shift generation processing has been selected in the menu.

The CPU 210 generates a shift for each generation based on a shift condition and the staff member information, and determines whether a shift condition for which an evaluation value does not become 100% even after a predetermined time has elapsed is present. That is, the CPU 210 detects a shift condition for which an evaluation value does not become 100% even after a predetermined time has elapsed (S202). When the CPU 210 determines that a shift condition for which an evaluation value does not become 100% even after a predetermined time has elapsed is not present (not detected) (S202: NO), the CPU 210 presents a shift that satisfies all the shift conditions, and ends the process.

When the CPU 210 determines that the shift condition for which the evaluation value does not become 100% even after the predetermined time has elapsed is present (detected) (S202: YES), the CPU 210 performs step S203. That is, the CPU 210 generates a shift based on only one of shift conditions for which evaluation values do not become 100% (S203).

The CPU 210 determines whether or not the evaluation value for the one shift condition for the shift generated in step S203 is 100% (S204).

When the CPU 210 determines that the evaluation value for the one shift condition for the shift generated in step S203 is 100% (S204: YES), the CPU 210 performs steps S205 to S209. When the CPU 210 determines that the evaluation value for the one shift condition for the shift generated in step S203 is not 100% (S204: NO), the CPU 210 performs S206.

The CPU 210 generates a shift based on only the one shift condition used to generate the shift in step S203 and another shift condition (S205).

The CPU 210 presents that it is impossible to set the evaluation value for the shift condition to 100% (S206). To be specific, The CPU 210 may present that it is impossible to set the evaluation value for the one shift condition used to generate the shift in step S203 to 100%.

The CPU 210 determines whether or not all of the evaluation values for the respective shift conditions for the shift generated in step S205 are 100% (S207).

When the CPU 210 determines that not all of the evaluation values for the shifts generated in step S205 are 100% (S207: NO), the CPU 210 performs S208. That is, the CPU 210 presents that the evaluation values for the other shift conditions decrease by increasing the priority of the shift condition used to generate the shift in step S203 (S208). Specifically, the CPU 210 may notify the one shift condition used to generate the shift in step S203, and present that the one shift condition conflicts with the other shift conditions.

When the CPU 210 determines that all of the evaluation values for the shift generated in step S205 are 100% (S207: YES), the CPU 210 performs S209. That is, the CPU 210 provides a notification that the evaluation value increases by increasing the priority of the shift condition used to generate the shift in step S203 (S209). Specifically, the CPU 210 may notify the one shift condition used to generate the shift in step S203, and notify that the evaluation value is increased by increasing the priority of the shift condition.

The embodiments produce the following effects.

A shift for a member is generated based on an accepted shift condition and accepted member information, and an achievement state of the shift condition is evaluated for the generated shift. Then, the effect of a change in the shift condition on the evaluation is predicted and presented. Thus, the complication of trial and error in the optimization of the shift condition in the automatic generation of the shift can be eliminated.

Furthermore, an achievement state is evaluated for each of shift conditions. Then, the effect on the evaluation is predicted based on whether or not the evaluation is improved by limiting the shift conditions to any one of the shift conditions of which the evaluated achievement states do not satisfy the predetermined criterion. Thus, a shift condition that cannot be achieved in the first place can be effectively presented in a short time. Then, complication of trial and error in the optimization of the shift condition in the automatic generation of the shift can be more simply and effectively eliminated.

In addition, the shift conditions are limited to two or more shift conditions including a shift condition for which evaluation is improved and a shift condition other than the shift condition for which evaluation is improved. Then, the effect on the evaluation is predicted based on whether or not all of the limited shift conditions are achieved. Thus, a shift condition that conflicts with another shift condition can be effectively detected in a short time.

Furthermore, the genetic algorithm is used to generate the shift. Thus, the complication of trial and error in the optimization of the shift condition in the automatic generation of the shift can be more effectively eliminated.

Furthermore, during the generation of the shift for each generation, in response to detection of a shift condition of which an achievement state does not satisfy the predetermined criterion even after a predetermined time has elapsed after the start of the generation of the shift, the shift is generated based on the detected shift condition. Then, it is predicted whether or not the evaluation is improved based on the shift generated based on the detected shift condition. Thus, it is possible to further reduce the complication of the manual processing in the optimization of the shift condition in the automatic generation of the shift and contribute to efficient shift generation.

In addition, in response to acceptance of one of a plurality of shift conditions used for generation of a shift, a shift is generated based on the one shift condition. Then, whether or not the evaluation is improved is predicted based on the shift generated based on the one shift condition. Thus, it is possible to further reduce the complication of the manual processing in the optimization of the shift condition in the automatic generation of the shift and contribute to efficient shift generation.

The present invention is not limited to the above-described embodiments, and various modifications can be made within the scope of the claims.

For example, each of the information processing terminal 100 and the server 200 may include constituent elements other than the above-described constituent elements, or may not include some of the above-described constituent elements.

In addition, the information processing terminal 100 and the server 200 may be separate apparatuses or may be a single apparatus.

Further, the function of each component may be implemented by another component. For example, at least a part of the processing described as being performed on the server 200 may be performed by the information processing terminal 100 or another apparatus. Alternatively, the information processing terminal 100 may be omitted by providing the server 200 with the functions of the information processing terminal 100.

Also, the processing units of the flowcharts in the above embodiments are divided according to the main processing contents in order to facilitate understanding of each processing. The present invention is not limited by the way of dividing the processing steps. Each processing may be divided into more processing steps. One processing step may execute additional processing. Also, multiple steps may be performed concurrently or in combination.

Means and methods for performing the various kinds of processing in the system according to the above-described embodiment can be implemented by any of a dedicated hardware circuit and a programmed computer. The computer-readable program may be provided, for example, by a non-transitory recording medium such as a flexible disk or a CD-ROM, or may be provided online via a network such as the Internet. In this case, the computer-readable program recorded on the non-transitory recording medium is usually transferred to and stored in a storage such as a hard disk. Furthermore, the program may be provided as independent application software, or may be incorporated in software of the apparatus as one function of the system.

Although embodiments of the present invention have been described and illustrated in detail, the disclosed embodiments are made for purpose of illustration and example only and not limitation. The scope of the present invention should be interpreted by terms of the appended claims.

What is claimed is:

1. A shift generation system comprising a hardware processor that accepts a shift condition and member information, generates a shift for a member based on the shift condition and the member information, evaluates an achievement state of the shift condition for the generated shift, predicts an effect of a change in the shift condition on the evaluation, and presents the predicted effect.

2. The shift generation system according to claim 1, wherein the hardware processor evaluates an achievement state for each of shift conditions, and predicts the effect on the evaluation based on whether or not the evaluation is improved by limiting the shift conditions to any one of the shift conditions of which the evaluated achievement states do not satisfy a predetermined criterion.

3. The shift generation system according to claim 2, wherein the hardware processor predicts the effect on the evaluation based on whether or not all of the limited shift conditions are achieved by limiting the shift conditions to two or more shift conditions including the shift condition for which the evaluation has been improved and the shift condition other than the shift condition for which the evaluation has been improved.

4. The shift generation system according to claim 1, wherein the hardware processor generates the shift using a genetic algorithm.

5. The shift generation system according to claim 2, wherein, during the generation of the shift for each generation using a genetic algorithm, in response to detection of the shift condition of which the achievement state does not satisfy the predetermined criterion even after lapse of a predetermined time from start of the generation of the shift, the hardware processor generates the shift based on the detected shift condition, and predicts whether or not the evaluation is improved based on the shift generated based on the detected shift condition.

6. The shift generation system according to claim 2, wherein the hardware processor generates the shift based on the plurality of shift conditions, generates, in response to acceptance of one of the plurality of shift conditions, the shift based on the one of the plurality of shift conditions, and predicts whether or not the evaluation is improved based on the shift generated based on the one of the plurality of shift conditions.

7. A shift generation method executed by a shift generation system that generates a shift for a member, the shift generation method comprising:
(a) accepting a shift condition and member information;
(b) generating the shift for the member based on the shift condition and the member information;
(c) evaluating an achievement state of the shift condition for the generated shift;
(d) predicting an effect of a change in the shift condition on the evaluation; and
(e) presenting the effect obtained in (d).

8. The shift generation method according to claim 7, wherein
in (c), an achievement state is evaluated for each of shift conditions, and
in (d), the effect on the evaluation is predicted based on whether or not the evaluation is improved by limiting the shift conditions to any one of the shift conditions of which the achievement states evaluated in (c) do not satisfy a predetermined criterion.

9. The shift generation system according to claim 8, wherein in (d), the effect on the evaluation is predicted based on whether or not all of the limited shift conditions are achieved by limiting the shift conditions to two or more shift conditions including the shift condition for which the evaluation has been improved and the shift condition other than the shift condition for which the evaluation has been improved.

10. The shift generation method according to claim 7, wherein in (b), the shift is generated using a genetic algorithm.

11. The shift generation method according to claim 8, further comprising (f) during the generation of the shift for each generation using the genetic algorithm in (b), in response to detection of the shift condition of which the achievement state does not satisfy the predetermined criterion even after lapse of a predetermined time from start of the generation of the shift, generating the shift based on the detected shift condition, wherein in (d), whether or not the evaluation is improved is predicted based on the shift generated based on the detected shift condition.

12. The shift generation method according to claim 8, wherein
in (b), the shift is generated based on the plurality of shift conditions,
the shift generation method further comprises (g) generating, in response to acceptance of one of the plurality of shift conditions in (a), the shift based on the one of the plurality of shift conditions, and
in (d), whether or not the evaluation is improved is predicted based on the shift generated based on the one of the plurality of shift conditions.

13. A non-transitory recording medium storing a computer-readable shift generation program for causing a computer to execute processing comprising:
(a) accepting a shift condition and member information;
(b) generating a shift for a member based on the shift condition and the member information;
(c) evaluating an achievement state of the shift condition for the generated shift;
(d) predicting an effect of a change in the shift condition on the evaluation; and
(e) presenting the effect obtained in (d).

14. The non-transitory recording medium storing the computer-readable shift generation program according to claim 13, wherein
in (c), an achievement state is evaluated for each of shift conditions,
in (d), the effect on the evaluation is predicted based on whether or not the evaluation is improved by limiting the shift conditions to any one of the shift conditions of which the achievement states evaluated in (c) do not satisfy a predetermined criterion.

15. The non-transitory recording medium storing the computer-readable shift generation program according to claim 14, wherein in (d), the effect on the evaluation is predicted based on whether or not all of the limited shift conditions are achieved by limiting the shift conditions to two or more shift conditions including the shift condition for which the evaluation has been improved and a shift condition other than the shift condition for which the evaluation has been improved.

16. The non-transitory recording medium storing the computer-readable shift generation program according to claim 13, wherein in (b), the shift is generated using a genetic algorithm.

17. The non-transitory recording medium storing the computer-readable shift generation program according to claim 14, further comprising (f) during the generation of the shift for each generation using the genetic algorithm in (b), in response to detection of the shift condition of which the achievement state does not satisfy the predetermined criterion even after lapse of a predetermined time from start of the generation of the shift, generating the shift based on the detected shift condition, wherein in (d), whether or not the evaluation is improved is predicted based on the shift generated based on the detected shift condition.

18. The non-transitory recording medium storing the computer-readable shift generation program according to claim 14, wherein
in (b), the shift is generated based on the plurality of shift conditions,
the processing further comprises (g) generating, in response to acceptance of one of the plurality of shift conditions in (a), the shift based on the one of the plurality of shift conditions, and
in (d), whether or not the evaluation is improved is predicted based on the shift generated based on the one of the plurality of shift conditions.
